(19) United States
(12) Patent Application Publication
(10) Pub. No.: US 2025/0337342 A1
(43) Pub. Date: Oct. 30, 2025

(54) MULTI-LEVEL CONVERTER WITH MECHANICALLY SWITCHED DISCHARGE RESISTOR AND EARTHING SWITCH

(71) Applicant: Maschinenfabrik Reinhausen GmbH, Regensburg (DE)

(72) Inventors: Ilknur Colak, Grenoble (FR); Josef Wittmann, Saal an der Donau (DE)

(21) Appl. No.: 18/866,621

(22) PCT Filed: May 8, 2023
(86) PCT No.: PCT/EP2023/062082

§ 371 Date: Nov. 18, 2024

(30) Foreign Application Priority Data
May 19, 2022 (DE) 10 2022 112 579.3

(51) Int. Cl. H02M 7/483; H02M 1/32; H02M 7/00

(52) U.S. Cl. CPC H02M 7/483; H02M 1/322; H02M 7/003

(57) ABSTRACT

A multi-level converter includes: a capacitor; a resistor; a first switch configured to be actuated by a first motor-drive unit; and a second switch configured to be actuated by a second motor-drive unit. The first switch, in a closed state, is configured to connect the capacitor to the resistor and to short-circuit the capacitor. The second switch, in a closed state, is configured to connect the capacitor to a ground potential.

### CROSS REFERENCE TO RELATED APPLICATIONS

This application is a U.S. National Phase application under 35 U.S.C. § 371 of International Application No. PCT/EP2023/062082, filed on May 8, 2023, and claims benefit to German Patent Application No. DE 10 2022 112 579.3, filed on May 19, 2022. The International Application was published in German on Nov. 23, 2023 as WO 2023/222420 A1 under PCT Article 21 (2).

### FIELD

The present disclosure relates to a multi-level converter.

### BACKGROUND

Multi-level converters basically consist of a multiplicity of semiconductor switches, capacitors and coils. The installed capacitors regularly store large amounts of energy. To ensure safe maintenance or fault correction of a multi-level converter, all elements should be put into a de-energized state prior to maintenance.

### SUMMARY

In an embodiment, the present disclosure provides a multi-level converter that includes: a capacitor; a resistor; a first switch configured to be actuated by a first motor-drive unit; and a second switch configured to be actuated by a second motor-drive unit. The first switch, in a closed state, is configured to connect the capacitor to the resistor and to short-circuit the capacitor. The second switch, in a closed state, is configured to connect the capacitor to a ground potential.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a circuit of a multi-level converter;

FIG. 2 shows a first detailed view of the multi-level converter having a first and a second switch;

FIG. 3 shows a second detailed view of the multi-level converter having the first and the second switch; and

FIG. 4 shows a detailed view of the first and the second switch.

### DETAILED DESCRIPTION

Aspects of the present disclosure provide a multi-level converter, which is easy to maintain, has a simple structure, and, furthermore, can be safely and repeatedly put into a de-energized state.

According to a first example embodiment, the present disclosure provides a multi-level converter, having:
a capacitor;
a resistor;
a first switch actuated by a first motor-drive unit; and
a second switch actuated by a second motor-drive unit; wherein:
   the first switch in a closed state connects the capacitor to the resistor and short-circuits said capacitor;
   the second switch in the closed state connects the capacitor to a ground potential;
   the first switch is closed before the second switch.

The multi-level converter is configured to be particularly simple and cost-effective to isolate, i.e. to discharge and to ground. The multi-level converter then assumes a de-energized state. The first and second switches have their own motor-drive units which are able to be controlled separately. After the capacitor is short-circuited by the first switch by means of a resistor or via the resistor, the capacitors are discharged as much as possible. The second switch finally grounds the capacitor and ensures that the multi-level converter is put into a de-energized state. When they are actuated, the switches are thus closed in a fixed sequence.

The multi-level converter can be configured in any way, wherein:
the first switch comprises a first and a second contact tooth;
the first and the second contact tooth are electrically conductively connected to the resistor;
the first contact tooth, the resistor and the second contact tooth form an electrical series connection.

The contact teeth each have contact surfaces.

The multi-level converter can be configured in any way, wherein:
the second switch comprises a moving contact;
the moving contact is electrically conductively connected to the ground potential.

The moving contact can be configured as a contact bar which is electrically conductively connected to the ground potential via cables, for example.

The multi-level converter can be configured in any way, wherein:
a contact module having a first connecting contact and a second connecting contact is provided;
the first connecting contact has a first contact point and a second contact point;
the second connecting contact has a first contact point and a second contact point.

The multi-level converter can be configured in any way, wherein:
in the closed state of the first switch, the first contact tooth makes contact with the first contact point of the first connecting contact and the second contact tooth makes contact with the first contact point of the second connecting contact; and
in the closed state of the second switch, the moving contact makes contact with the second contact point of the first connecting contact and second contact point of the second connecting contact.

The first switch is thus formed of the contact teeth and the first contact points of the first and second connecting contacts. The second switch is thus formed of the moving contact and the second contact points of the first and second connecting contacts.

Alternatively, the contact bar makes contact with the first and second connecting contacts.

The multi-level converter can be configured in any way, wherein:
the capacitor is part of a cell.

The multi-level converter can be configured in any way, wherein:
a plurality of capacitors are provided which are part of a single cell;
a plurality of cells are provided;
each cell is assigned in each case a first and a second connecting contact;
each cell can be discharged in each case via two contact teeth and a resistor;
each cell can be grounded via a common moving contact.

Depending on the requirements, a multi-level converter can have a plurality of capacitors that are arranged individually or together in cells. In an embodiment having a plurality of cells, each of the cells must be configured to be connectable to the first and the second switch. Each cell can be allocated a separate resistor or a plurality of resistors. Each cell is connected to a common second switch so that it can be connected to the ground potential via the second switch. Each cell can be allocated its own first switch which discharges the capacitors of the cells.

The multi-level converter can be configured in any way, wherein:
twelve cells are provided and each cell emits a voltage of 2 kV.

The multi-level converter can be configured in any way, wherein:
the multi-level converter operates in a medium-voltage range of 20 kV.

The multi-level converter can be configured in any way, wherein:
each cell has at least one semiconductor switching element and one inductor.

According to a further example embodiment of the present disclosure, a method for isolating a multi-level converter is provided, wherein:
in a first step, the first switch is actuated by a first motor-drive unit and thereby short-circuits a capacitor by means of a resistor;
in a second step, the second switch is actuated by a second motor-drive unit and thereby connects the capacitor to a ground potential; and
the second step is only carried out if the capacitor has been discharged.

During the isolation, that is to say the switching of the multi-level converter to a de-energized state, the capacitors are discharged and after they have been discharged additional grounding of the capacitors is carried out. In a particularly preferred embodiment, it is important that the grounding, that is to say the actuation of the second switch, only takes place if the capacitors have been completely or at least almost completely discharged. This enables safe operation on the multi-level converter.

Identical reference signs are used for identical or identically acting elements of the present disclosure. Furthermore, for the sake of clarity, in the individual figures, only reference signs necessary for the description of the respective figure are illustrated. The illustrated embodiments merely constitute examples of how the multi-level converter according to the present disclosure can be configured and thus do not constitute a conclusive delimitation of the present disclosure.

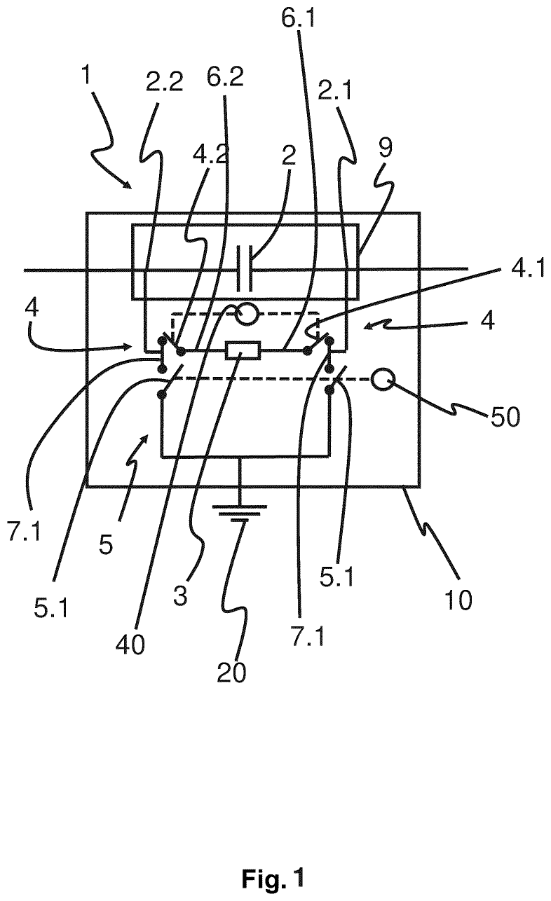

FIG. 1 shows a first embodiment of a multi-level converter 1. The latter has at least one capacitor 2 which is part of a cell 9. Furthermore, at least one resistor 3 is provided, which with the aid of a first switch 4 and a first motor-drive unit 40 can be connected in parallel with the capacitor 2 or can be connected thereto, as a result of which the capacitor 2 is short-circuited by means of or via the resistor 3. Furthermore, a second switch 5 is provided, which with the aid of a second motor-drive unit 50 can connect the capacitor 2 to a ground potential 20. When the capacitor 2 is short-circuited by means of or via the resistor 3, the discharge of the capacitor 2 takes place. When the capacitor 2 is connected to the ground potential 20, the capacitor 2 is grounded. The short-circuiting is always performed before the grounding. After the short-circuiting, the associated discharging of the capacitor and the grounding, work, such as, e.g., maintenance, etc., can be carried out on the multi-level converter without any risk to persons. In the embodiment shown here, the multi-level converter 1 has a cell 9 having a capacitor 2. Preferably, the multi-level converter 1 can have twelve cells 9 each having at least one capacitor 2.

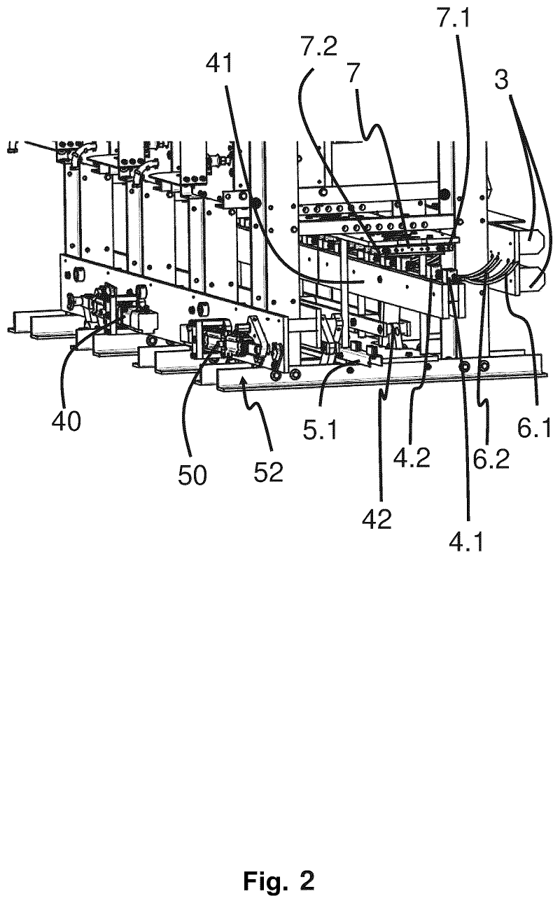

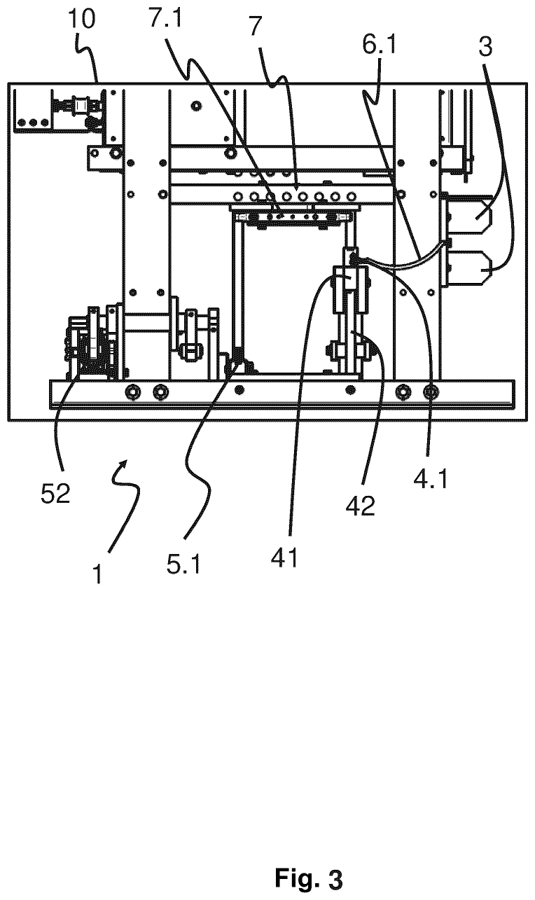

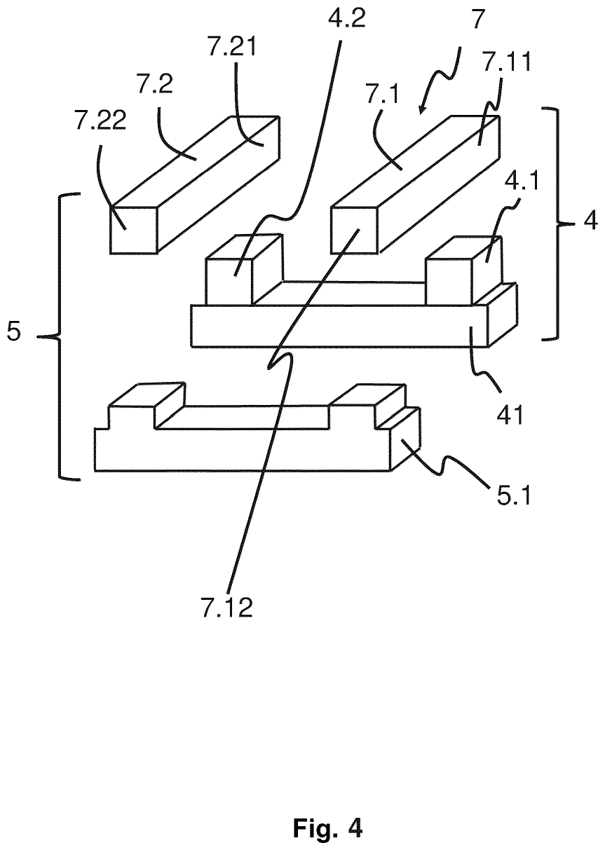

FIGS. 2 to 4 show a detailed illustration of the multi-level converter 1, and of the first and second switches 4, 5. All elements of the multi-level converter 1 are arranged in a housing 10 with a frame. The first switch 4 has at least one first contact tooth 4.1 and a second contact tooth 4.2. Each contact tooth consists of a carrier having a first and a second contact plate, wherein the contact plates are arranged on two opposite sides of the carrier. Each of the contact teeth 4.1, 4.2 or the contact plates of each contact tooth are preferably electrically conductively connected to at least one resistor 3 via a first and a second line 6.1, 6.2. The contact teeth 4.1, 4.2 and the at least one resistor 3 form an electrical series connection via the lines 6.1, 6.2. Furthermore, the contact teeth 4.1, 4.2 are arranged on a switching strip 41. The switching strip 41 is configured from a non-conductive material so that the two contact teeth 4.1, 4.2 are insulated from one another, that is to say do not conduct electricity to one another. The switching strip 41 is preferably connected to the first motor-drive unit 40 via a mechanism 42 which, for example, is in the form of a knee-lever device. The first motor-drive unit 40 is preferably in the form of a linear motor having a rotating spindle.

The second switch 5 has a moving contact 5.1 which is in the form of a contact bar. The moving contact 5.1 or the bar is preferably connected to the ground potential 20 via a line. The second switch 5 and in particular its moving contact 5.1 is preferably actuated via a further mechanism 52, which is for example in the form of a knee-lever device, and the second motor-drive unit 50. The second motor-drive unit 50 is preferably in the form of a linear motor having a rotating spindle.

Furthermore, a contact module 7 is provided, which can be connected from both the first and the second switch 4, 5. In this case, the contact module 7 has at least one first connecting contact 7.1 and at least one second connecting contact 7.2 which are arranged on an insulating-material carrier. Both connecting contacts 7.1, 7.2 each have a first contact point 7.11, 7.21 and a second contact point 7.12, 7.22. The first connecting contact 7.1 is electrically conductively connected to a first side 2.1 of the capacitor 2 and the second connecting contact 7.2 to a second side 2.2.

The first motor-drive unit 40 actuates the first switch 4 in such a way that the first motor-drive unit 40 operates the mechanism 42 on the switching strip 41. In this case, the switching strip 41 carries out a vertical movement from the bottom to the top toward the contact module 7. When the first switch 4 is actuated, the first contact tooth 4.1 is thus connected via the first contact point 7.11 of the first connecting contact 7.1 and the second contact tooth 4.2 via the first contact point 7.21 of the second connecting contact 7.2. In this case, the capacitor 2 is short-circuited via the resistor 3 and discharged.

The second motor-drive unit 50 actuates the second switch 5 in such a way that the second motor-drive unit 50 acts on the moving contact 5.1 by means of the mechanism 52. In this case, the moving contact 5.1 carries out a vertical movement from the bottom to the top toward the contact module 7. In this case, it is preferable to cover a distance of at least 280 mm. This distance is intended in particular for an operating range of the multi-level converter of 20 kV. In other words, the second contact points 7.12, 7.22 of the connecting contacts 7.1, 7.2 in the open, that is to say non-conductive, state are at least 280 mm away from the moving contact 5.1. When the second switch 5 is actuated, the moving contact 5.1 is thus electrically conductively connected to the connecting contacts 7.1, 7.2 via the respective second contact points 7.12, 7.22. This establishes a connection between the ground potential 20 and the capacitor 4; the capacitor 2 is grounded.

The connecting contacts 7.1, 7.2 of the contact module 7 thus provide a common contact point for the connection to the resistor 3 and to the ground potential 20. Both the switching strip 41 and the moving contact 5.1, which is in the form of a bar, are moved by the corresponding motor-drive units 40, 50 via a vertical movement and finally make the connection.

In this case, the actuation of the first switch 4, that is to say the switching strip 41, having the contact teeth 4.1, 4.2 is always performed before the actuation of the second switch 5, that is to say the first moving contact 5.1. Between the actuation of the first switch 4 and the second switch 5, a defined period of time must be observed in which a complete discharge of the capacitor can be assumed. The connecting contacts 7.1, 7.2 of the switching strip 7 are preferably configured as spring-loaded contact blades.

The multi-level converter 1 can have a plurality of capacitors 2. Preferably, each capacitor is assigned in each case a first switch, a second switch and a resistor. In the case of a plurality of first switches, these are driven or actuated together via the first motor-drive unit 40. A plurality of second switches are driven or actuated together via the second motor-drive unit 50.

The motor-drive units 40, 50 are actuated or controlled by a control device. The control device has means or is correspondingly set up in such a way that, every time, the first motor-drive unit 40 and then the second motor-drive unit 50 is actuated. For this purpose, the multi-level converter 1 can have limit switches which transmit the actuation of the first and second switches 4, 5 to the control device. This establishes the switching sequence of the first and second switches 4, 5.

In a multi-level converter having a plurality of cells 9 and a plurality of capacitors 2, the switches 4, 5 are correspondingly present several times. The contact module 7 correspondingly has a pair of separate connecting contacts 7.1, 7.2 for each cell 9 or capacitor 2. A pair of contact teeth 4.1, 4.2 having corresponding contact surfaces are also present in each case. The moving contact 5.1 has a correspondingly large configuration such that it can make contact with all of the connecting contacts of the multi-level converter and can thus ground a plurality of cells 9 having all of the capacitors 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 multi-level converter
2 capacitor
3 resistor
4 first switch
4.1 first contact tooth
4.2 second contact tooth
5 second switch
6.1 first line
6.2 second line
7 contact module
7.1 first connecting contact
7.2 second connecting contact
7.11 first contact point of 7.1
7.21 first contact point of 7.2
7.12 second contact point of 7.1
7.22 second contact point of 7.2
9 cell
10 housing
20 ground potential
40 first motor-drive unit
42 mechanism
50 second motor-drive unit
52 mechanism

1. A multi-level converter, the multi-level converter comprising:
a capacitor;
a resistor;
a first switch configured to be actuated by a first motor-drive unit; and
a second switch configured to be actuated by a second motor-drive unit;
wherein:
the first switch, in a closed state, is configured to connect the capacitor to the resistor and to short-circuit the capacitor; and
the second switch, in a closed state, is configured to connect the capacitor to a ground potential.

2. The multi-level converter as claimed in claim 1, wherein:
the first switch comprises a first contact tooth and a second contact tooth;
the first contact tooth and the second contact tooth are electrically conductively connected to the resistor; and
the first contact tooth, the resistor, and the second contact tooth form an electrical series connection.

3. The multi-level converter as claimed in claim 1, wherein;
the second switch comprises a moving contact; and
the moving contact is electrically conductively connected to the ground potential.

4. The multi-level converter as claimed in claim, wherein:
the multi-level converter further comprises a contact module comprising a first connecting contact and a second connecting contact is provided;
the first connecting contact comprises a first contact point and a second contact point; and
the second connecting contact has a first contact point and a second contact point.

5. The multi-level converter as claimed in claim 1, wherein:
in the closed state of the first switch, the first contact tooth is configured to make contact with the first contact point of the first connecting contact and the second contact tooth is configured to make contact with the first contact point of the second connecting contact; and
in the closed state of the second switch, the moving contact is configured to make contact with the second contact point of the first connecting contact and the second contact point of the second connecting contact.

6. The multi-level converter as claimed in claim 1, wherein:
the multi-level converter further comprising a cell; and the capacitor is part of the cell.

7. The multi-level converter as claimed in claim 1, wherein:
the cell comprises a plurality of capacitors.

8. The multi-level converter as claimed in claim 1, wherein:
the multi-level converter further comprises a plurality of cells provided;
each cell, of the plurality of cells, is respectively assigned first connecting contact and a second connecting contact;
each cell is configured to be discharged via two contact teeth and a resistor; and
each cell is configured to be grounded via a common moving contact.

9. The multi-level converter as claimed in claim 1, wherein:
the multi-level converter further comprises twelve cells and each cell is configured to emit a voltage of 2 kV.

10. The multi-level converter as claimed in claim 1, wherein:
the multi-level converter is configured to operate in a medium-voltage range of 20 kV.

11. The multi-level converter as claimed in claim 1, wherein:
the multi-level converter further comprises a plurality of cells, each cell having at least one semiconductor switching element and one inductor.

12. A method for isolating the multi-level converter as claimed in claim 1, the method comprising:
actuating the first switch by the first motor-drive unit and thereby short-circuiting the capacitor with the resistor; and
actuating the second switch by the second motor-drive unit and thereby connecting the capacitor to the ground potential;
wherein the second step is only carried out upon the capacitor being discharged.
